(19) United States
(12) Patent Application Publication
(10) Pub. No.: US 2025/0247461 A1
(43) Pub. Date: Jul. 31, 2025

(54) Smart Photo Frame

(71) Applicant: SolTech Texas LLC, Houston, TX (US)

(72) Inventor: Ozkan Oz, Houston, TX (US)

(21) Appl. No.: 18/793,470

(22) Filed: Aug. 2, 2024

Related U.S. Application Data
(60) Provisional application No. 63/625,056, filed on Jan. 25, 2024.

(51) Int. Cl. H04M 1/72412; A47G 1/06; G06F 3/14; G06K 7/10; G06K 19/07; H04M 1/72445

(52) U.S. Cl. CPC H04M 1/72412; A47G 1/06; G06F 3/14; G06K 7/10366; G06K 19/0723; H04M 1/72445

(57) ABSTRACT

The present invention is a smart photo frame with a built-in NPC chip. The NFC chip allows the user to tap a phone or smart device to the frame to access a variety of features, including displaying, sharing, storing, and editing photos or videos. The invention includes a unique serial number or identifier to access the smart features and ensure security.

The current application claims a priority to the U.S. Provisional Patent application Ser. No. 63/625,056 filed on Jan. 25, 2024.

### FIELD OF THE INVENTION

The present invention relates generally to photo frames. More specifically, the present invention is a photo frame integrating an embedded NFC chip to allow for additional functionalities.

### BACKGROUND OF THE INVENTION

Although smart photo frames already offer many more useful features than regular photo frames, current smart photo frames are still not “smart” enough. It is an object of the present invention to address this issue by providing users with a photo frame integrating an embedded NFC chip to allow for additional functionalities.

### BRIEF DESCRIPTION OF THE DRAWINGS

FIG. 1 is a view of the present invention with a landscape orientation;

FIG. 2 is a view of the present invention with a portrait orientation;

FIG. 3 is rear view of the present invention; and

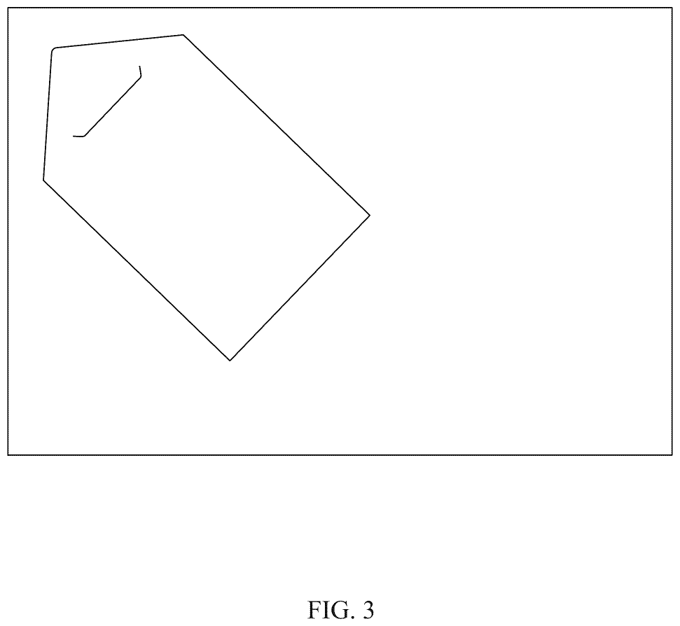

FIG. 4 is a detailed view of the present invention with a landscape orientation.

### DETAILED DESCRIPTION OF THE INVENTION

All illustrations of the drawings are for the purpose of describing selected versions of the present invention and are not intended to limit the scope of the present invention.

The present invention is a smart photo frame (1) integrating an embedded near-field communication (NFC) chip (2). Users can seamlessly incorporate traditional printed photos, turning an ordinary frame into an interactive experience. Each frame is uniquely identified by a serial number, a critical element in activating its interactive features.

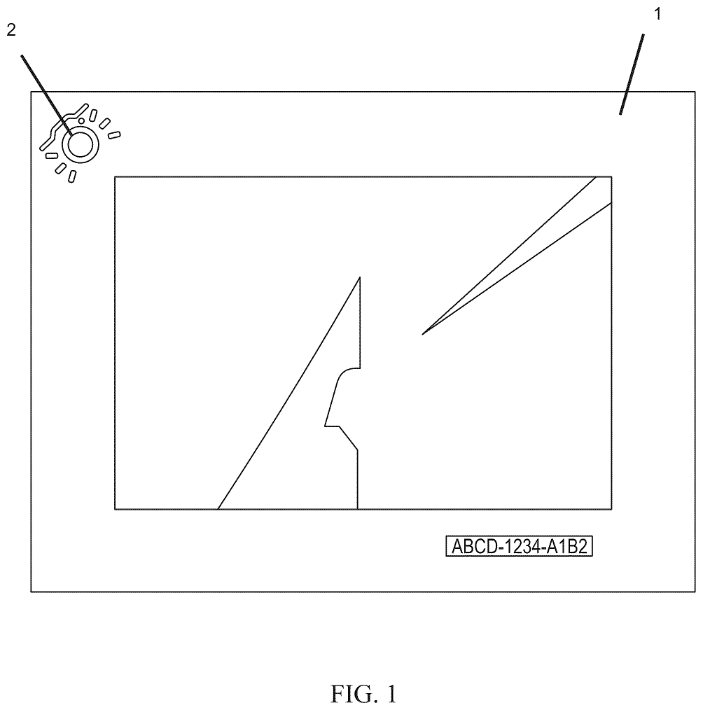

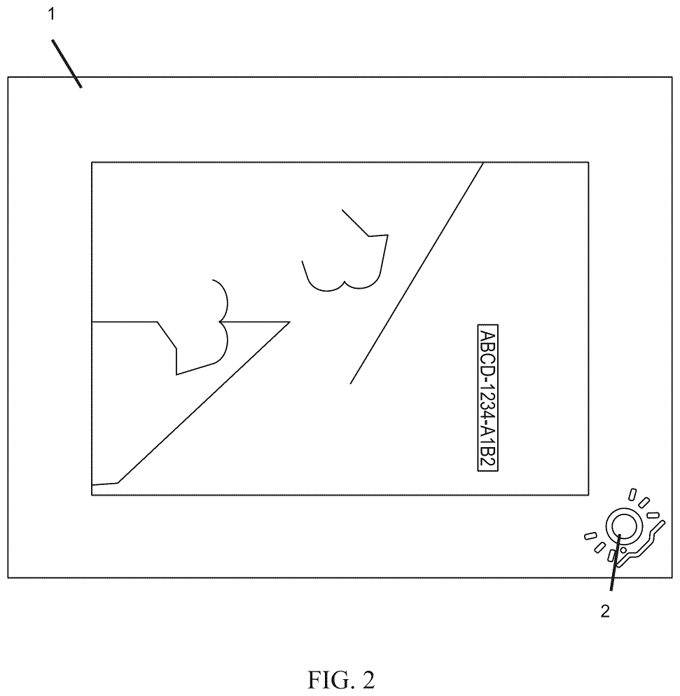

The present invention introduces a novel way of displaying photos. The frame (1) may comprise materials such cardboard, wood, metal, or any other material typically used for photo frames. The frame (1) houses an NFC chip (2), preferably positioned in one of its corners. This strategic placement allows users to tap their smartphones on the NFC-enabled area, initiating a seamless connection. FIG. 1 and FIG. 2 show examples of frames with NFC-chips.

The frame (1) allows for flexibility in material, ensuring compatibility with various aesthetic preferences. The NFC chip (2) is seamlessly incorporated into the chosen corner or specific area during the manufacturing process. The serial number, unique to each frame, serves as a key identifier for activation.

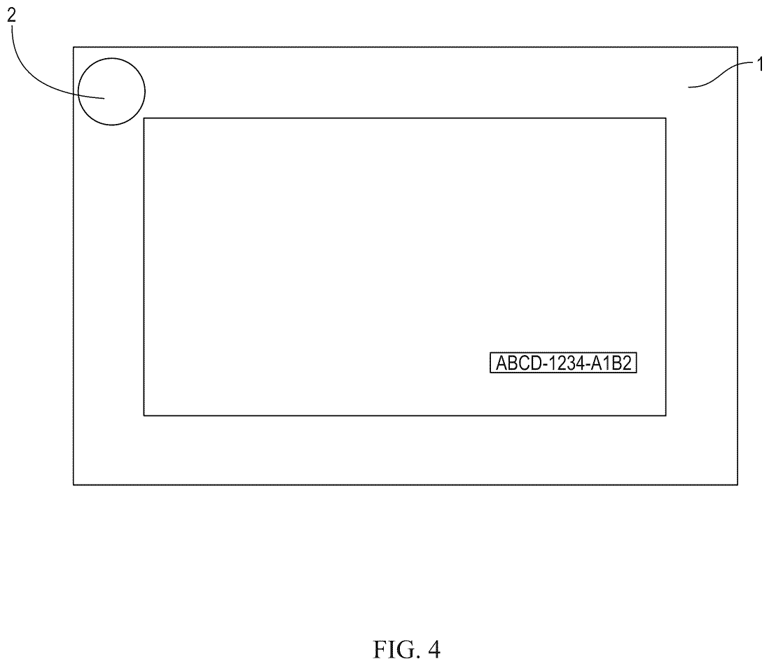

The present invention comprises:
Frame material: versatile options such as cardboard, wood, or metal.
NFC chip (2): preferably embedded in a corner for seamless interaction.
Serial number: uniquely assigned for key activation, as shown in FIG. 4.
Application independence: works effortlessly without the need for a dedicated app.

During manufacturing, the NFC chip (2) is precisely integrated into the frame's selected corner or area. Each frame (1) receives a unique serial number during production, ensuring a user-friendly experience.

The present invention is not merely a display tool but a convergence of aesthetics and technological innovation. Its application independence and straightforward operation set it apart from conventional frames.

### Integration of NFC Technology:

The NFC chip (2), a pivotal component of the present invention, boasts a versatile placement strategy. It can be positioned on the top, in the middle, or under the backside of the frame material.

The specific location of the NFC chip is adaptive, responding to the frame material's characteristics, thickness, and overall design. This dynamic feature ensures compatibility with various frame types, making the present invention inclusive and comprehensive.

Regardless of the frame's material or design, the present invention relates to any frame embedded with an NFC chip. Placement flexibility empowers designers and manufacturers to integrate the NFC chip seamlessly, ensuring widespread applicability.

### Frame Materials and NFC Chip Placement:

The present invention accommodates a broad spectrum of frame materials, including but not limited to silicon, silver, gold, plastic, and glass. The present invention embraces the diversity in materials, offering flexibility to suit diverse design preferences and applications.

The NFC chip integration methods are equally versatile. Whether inlayed, embedded, or attached, the present invention encompasses all approaches. This flexibility encourages innovation in design while maintaining the core functionality of the present invention.

### Serial Number and Key Activation:

The concept of a serial number extends beyond traditional alphanumeric combinations. The present invention covers a comprehensive range of registration identifiers, including PINs, passwords, or any alphanumeric sequence.

The essence lies in the exclusivity of the registration process. Any form of unique identification, regardless of nomenclature, falls under the scope of the present invention. This extends to registrations without an application, emphasizing the present invention's reach across varied implementations.

### Application-Independent Operation:

The present invention distinguishes itself by offering a dual-mode operation, both with and without an application. This dual functionality ensures that the interactive features are not limited to app-based experiences.

While the system operates seamlessly without an application, the present invention explicitly has innovative features when integrated with an application. This foresightedness safeguards against potential attempts to replicate the present invention's functionalities solely through an application.

### Activation Mechanism:

The present invention's interactive interface extends beyond the basic tapping functionality. Users can enhance their photo galleries by including the date of the event, a title, tagline, and even toggle between dark and light modes.

Additionally, the system supports the generation of a QR code linked to the album, facilitating easy sharing. Customers can also access more photos through a dedicated link to their cloud storage. This comprehensive feature set ensures a rich and engaging user experience, covering both application-independent and application-based models.

### User Control and Customization:

Users have granular control over the privacy settings of their albums. They can designate albums as public or private, even after the initial upload. This dynamic control is facilitated through our secure server and membership login system.

This level of control extends to the ability to delete albums, providing users with autonomy over their content. The present invention includes both server-based operations, ensuring the longevity of the innovation, and potential future application-based functionalities.

The present invention emphasizes versatility and adaptability. The NFC chip (2) allows users to display, share, store and edit photos or videos in a variety of customizable ways.

Although the invention has been explained in relation to its preferred embodiment, it is to be understood that many other possible modifications and variations can be made without departing from the spirit and scope of the invention.

What is claimed is:

1. A smart photo frame comprising,
a frame;
an integrated NFC chip, said NFC chip integrated into the frame allowing the user to interact with the NFC chip; and
a serial number or other unique identifier.

2. The smart photo frame of claim 1, wherein the integrated NFC chip allows the user to tap the smart photo frame with a smartphone or other device, thereby activating the smart features of the smart photo frame, and the serial number or other unique identifier ensures security.

3. The smart photo frame of claim 1, wherein the smart features comprise displaying, sharing, storing, and editing a digital photo or video collection via the NFC chip and serial number or other unique identifier.

4. The smart photo frame of claim 1, wherein the smart features may be accessed through a web browser or a dedicated application.
